(19) United States
(12) Patent Application Publication
(10) Pub. No.: US 2024/0205354 A1
(43) Pub. Date: Jun. 20, 2024

(54) SCANNING SYSTEM, FILE GENERATING METHOD, AND STORAGE MEDIUM STORING PROGRAM

(71) Applicant: SEIKO EPSON CORPORATION, TOKYO (JP)

(72) Inventor: Hideaki KAWANO, SHIOJIRI-SHI (JP)

(21) Appl. No.: 18/540,960

(22) Filed: Dec. 15, 2023

(30) Foreign Application Priority Data
Dec. 15, 2022 (JP) 2022-200019

(51) Int. Cl. H04N 1/62; H04N 1/00

(52) U.S. Cl. CPC H04N 1/62; H04N 1/00816

(57) ABSTRACT

A scanning system includes a smoother that performs smoothing on image data and a merger that analyzes the image data on which the smoothing is performed and generates a highly compressed PDF file. The smoother performs smoothing using the pixel value of a pixel other than a pixel of a background color among pixels included in an area in which the smoothing is to be performed.

The present application is based on, and claims priority from JP Application Serial Number 2022-200019, filed Dec. 15, 2022, the disclosure of which is hereby incorporated by reference herein in its entirety.

### BACKGROUND

### 1. Technical Field

The present disclosure relates to a scanning system, a file generating method, and a storage medium storing a program.

### 2. Related Art

It has recently been desired that an original document be scanned and stored as electronic data, instead of being stored in paper form. In this regard, as disclosed, for example, in JP-A-2008-99149, there are known techniques that separate an image representing only characters and an image representing non-characters from an original image obtained by scanning an original document, and compress the separated images using compression techniques respectively suitable for the separated images, thereby effectively compressing the original image.

In addition, JP-A-2008-99149 discloses techniques for addressing a disadvantage in which, in color images output by a scanner, the color of, for example, a character shifts from the original color and thus the color of a character (hereafter referred to as a “character color”) is not able to be detected with a high accuracy. Specifically, in the disclosed techniques, in order to avoid an adverse effect of color-shifted pixels on detection of a character color, the pixels of edges of a character are removed and the character is thinned, and thus the character color is detected using only the pixels at the center of the character.

However, when the original character is composed of thin lines, the techniques described above of JP-A-2008-99149 have the following disadvantage. If the edge pixels are removed in this case, the number of pixels used for detection of a character color is remarkably decreased, thereby possibly making it difficult to properly identify the character color and making it difficult to further thin the lines. Therefore, the option for identifying the character color is limited to using color-shifted pixels.

### SUMMARY

According to an aspect of the present disclosure, a scanning system includes a scanner configured to scan an original document to generate image data; a smoother configured to perform smoothing on the image data; a classifier configured to analyze the image data on which the smoothing is performed, to differentiate between a pixel constituting a character and a pixel constituting a non-character in an image represented by the image data; a layer generator configured to, according to the differentiation between the pixels, generate, from the image data, a character layer including the pixel constituting a character and a non-character layer including the pixel constituting a non-character; a compression section configured to compress the character layer and the non-character layer by respectively different compression methods; and a merger configured to generate a file into which data on the compressed character layer and data on the compressed non-character layer are merged. In the scanning system, the smoother performs the smoothing using a pixel value of a pixel other than a pixel of a background color among pixels included in an area to be processed.

According to another aspect of the present disclosure, a file generating method includes performing smoothing on image data; analyzing the image data on which the smoothing is performed, to differentiate between a pixel constituting a character and a pixel constituting a non-character in an image represented by the image data; according to the differentiation between the pixels, generating a character layer, the character layer being a layer including the pixel constituting a character, and a non-character layer, the non-character layer being a layer including the pixel constituting a non-character, from the image data; compressing the character layer and the non-character layer by respectively different compression methods; and generating a file into which data on the compressed character layer and data on the compressed non-character layer are merged. In the file generating method, in the smoothing, processing is performed using a pixel value of a pixel other than a pixel of a background color among pixels included in an area to be processed.

According to another aspect of the present disclosure, a non-transitory computer-readable storage medium storing a program that causes a computer to execute: a smoothing step of performing smoothing on image data; a classifying step of analyzing the image data on which the smoothing is performed, to differentiate between a pixel constituting a character and a pixel constituting a non-character in an image represented by the image data; a layer generating step of, according to the differentiation between the pixels, generating a character layer, the character layer being a layer including the pixel constituting a character, and a non-character layer, the non-character layer being a layer including the pixel constituting a non-character, from the image data; a compressing step of compressing the character layer and the non-character layer by respectively different compression methods; and a merging step of generating a file into which data on the compressed character layer and data on the compressed non-character layer are merged. In the smoothing step, the smoothing is performed using a pixel value of a pixel other than a pixel of a background color among pixels included in an area to be processed.

### BRIEF DESCRIPTION OF THE DRAWINGS

FIG. 1 is a block diagram illustrating an exemplary configuration of a scanning system according to an embodiment.

FIG. 2 is a block diagram illustrating an exemplary functional configuration of an image processing device according to the embodiment.

FIG. 3 is a schematic depiction of an exemplary original document to be scanned by a scanner.

FIG. 4 is a graph illustrating exemplary histograms when an original document of white paper is scanned by a scanner.

FIG. 5 is a schematic diagram of an exemplary method of determining the range of a background color.

FIG. 6 is a schematic depiction of division of an image.

FIG. 7 is a schematic depiction of the range of pixels that are input to a smoothing filter for correction of a target pixel.

FIG. 8 is a schematic illustration illustrating whether each pixel included in a target range is used for smoothing.

FIG. 9 is a schematic illustration illustrating exemplary filter coefficients.

FIG. 10 is a schematic depiction of an example of a first character layer generated by a layer generator.

FIG. 11 is a schematic depiction of an example of a second character layer generated by the layer generator.

FIG. 12 is a schematic depiction representing an example of a non-character layer generated by the layer generator.

FIG. 13 is a flowchart illustrating an example of the flow of operations of the scanning system according to the embodiment.

FIG. 14 includes diagrams illustrating effects of correction of color shifts caused by scanning.

FIG. 15 includes diagrams illustrating effects of correction of color shifts caused by scanning.

FIG. 16 includes diagrams illustrating effects of correction of noise caused by conversion to JPEG data.

FIG. 17 includes diagrams illustrating effects of correction of noise caused by conversion to JPEG data.

FIG. 18 illustrates a comparison of processing results obtained when smoothing is performed without exclusion of pixel values of a background color and when smoothing is performed with exclusion of pixel values of the background color.

FIG. 19 illustrates a comparison of processing results obtained when smoothing is performed without exclusion of pixel values of a background color and when smoothing is performed with exclusion of pixel values of the background color.

FIG. 20 is a block diagram illustrating an exemplary hardware configuration of an image processing device according to the embodiment.

### DESCRIPTION OF EMBODIMENTS

Embodiments will be described below with reference to the accompanying figures. For the purpose of clarity of explanation, the following description and figures are omitted or simplified as appropriate. In addition, in each figure, the same elements are denoted by the same reference numerals, and repetitive description is omitted as desired.

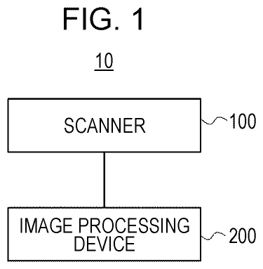

FIG. 1 is a block diagram illustrating an exemplary configuration of a scanning system 10 according to an embodiment. The scanning system 10 includes a scanner 100 and an image processing device 200. The scanner 100 and the image processing device 200 may be configured as an indivisible device, such as a multi-function printer, or as separate devices communicatively coupled to each other. When the scanning system 10 is configured as a multi-function printer, the scanning system 10 may include functionality, such as print functionality and fax functionality. When the scanner 100 and the image processing device 200 are configured as separate devices communicatively coupled to each other, the image processing device 200 may be any device as long as it functions as a computer, and may be a server, a personal computer, a tablet computer, a smartphone, or the like.

The scanner 100 scans an original document to generate image data. For example, the scanner 100 optically reads an original document by scanning the original document in a predetermined direction, that is, a sub-scanning direction, using a light source and a sensor to generate color image data. The scanner 100 outputs the generated image data to the image processing device 200. Herein, the original document is, for example, a paper medium but may be a medium of a material other than paper. According to the present embodiment, specifically, the scanner 100 generates RGB data in which each pixel is composed of color components of read (R), green (G), and blue (B). The scanner 100 may include an auto document feeder (ADF) that automatically transports an original document to be scanned, page by page in order.

In image data generated by the scanner 100 scanning an original document, a color shift may occur. Herein, the color shift refers to a shift in the color of an image, represented by image data, from the original color of an image of the original document. For example, when an original document on which a black character is printed is scanned, all the pixels of the pixel group constituting the character are desirably black pixels. In reality, however, in image data, the character is constituted by pixels of various colors slightly shifted from black. This degrades the accuracy of processing in generating an image obtained by extracting only characters from image data, that is, in generating a character layer described later. In other words, it becomes difficult to extract only characters with good accuracy. In addition, in determining the color of a character included in a character layer, the accuracy of processing is degraded. That is, it becomes difficult to properly identify the color of a character. Therefore, according to the present embodiment, the image processing device 200 performs processing for reducing degradation in the processing described above.

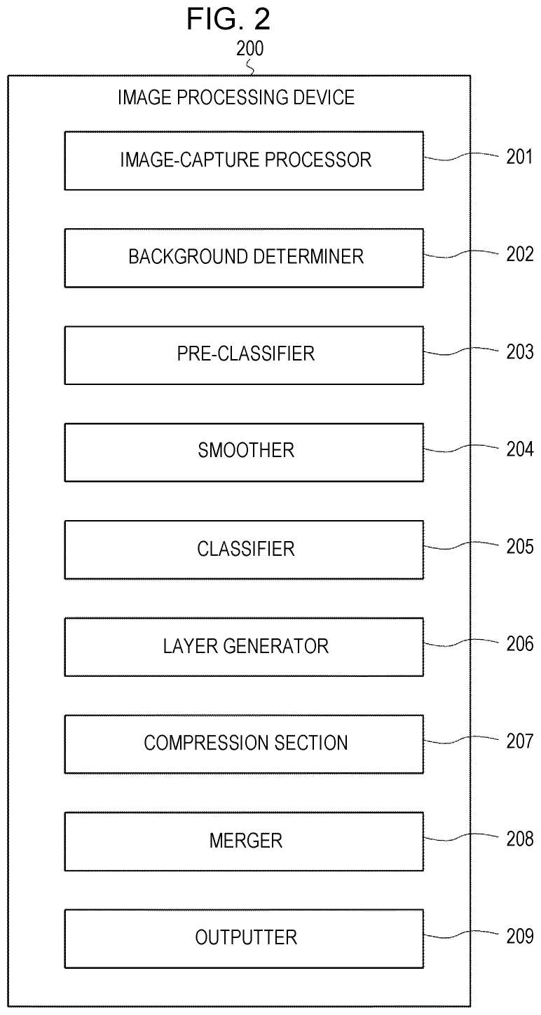

The image processing device 200 will be specifically described below. FIG. 2 is a block diagram illustrating an exemplary functional configuration of the image processing device 200. The image processing device 200 includes an image-capture processor 201, a background determiner 202, a pre-classifier 203, a smoother 204, a classifier 205, a layer generator 206, a compression section 207, a merger 208, and an outputter 209. The image processing device 200 is a device that performs processing of obtaining an image of an original document scanned by the scanner 100 and compressing the image. Specifically, the image processing device 200 is a device that generates a portable document format (PDF) file including compressed data of a character layer and compressed data of a non-character layer from image data generated by scanning.

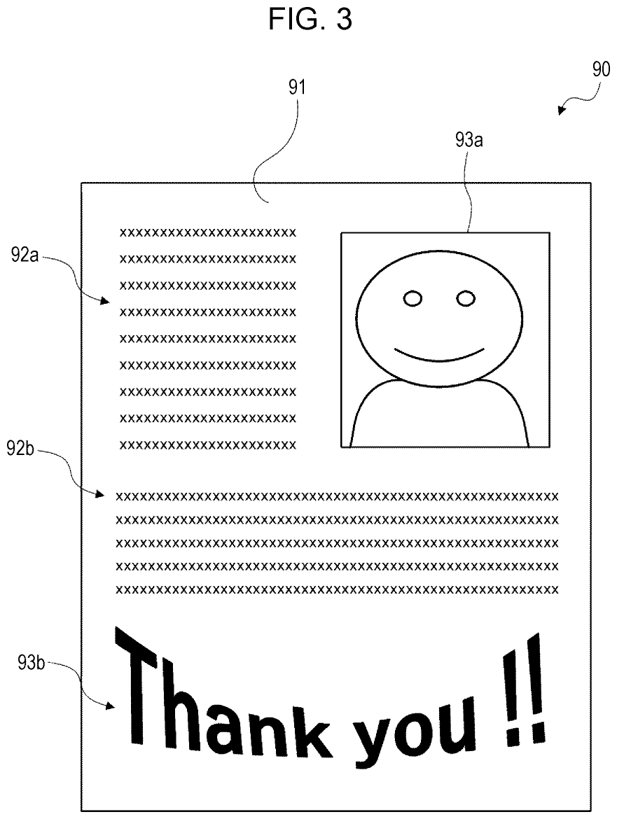

FIG. 3 is a schematic depiction of an example of an original document 90 to be scanned by the scanner 100. In the depicted original document 90, for example, character strings 92a and 92b and illustrations 93a and 93b are arranged on a background 91. The character string 92a and the character string 92b may differ in color. For example, the character string 92a may be a black character string and the character string 92b may be a red character string. As a matter of course, the total number of colors of characters included in the original document 90 is not limited to two or less and may be three or more. In the present disclosure, the illustration refers to an element other than a character in a predetermined font and with a size smaller than or equal to a predetermined value, and examples of the illustration include a photograph, a pictorial pattern, a table, and a decorated character. In the example depicted in FIG. 3, the original document 90 includes the illustration 93a, which is a photograph, and the illustration 93b, which is a decorated character. The decorated character as used here refers to a character designed as an illustration.

The image-capture processor 201 performs processing of obtaining image data to be compressed. According to the present embodiment, the image-capture processor 201 converts image data in an RGB data format output from the scanner 100 to Joint Photographic Experts Group (JPEG) data and temporarily stores the JPEG data in the storage device 254 described later. This may reduce the delay in the processing of the scanner 100 even when, during sequential output of image data from the scanner 100, the processing speed of the image processing device 200 is lower than the processing speed of the scanner 100.

Then, in order to perform compression of image data, the image-capture processor 201 reads out image data corresponding to one page stored in the storage device 254 and stores the image data in a memory 252 described later. More specifically, the image data is stored in a random access memory (RAM). According to the present embodiment, specifically, the image-capture processor 201 decodes the JPEG data read out from the storage device 254 into RGB data and then converts the RGB data to YUV data, and stores the YUV data in the memory 252. The YUV data is image data that represents the color of each pixel using a combination of a luminance signal Y and difference signals U and V, which are each between the luminance signal and a color component.

The color shifts (noise) may occur also in conversion to JPEG data. According to the present embodiment, as described above, the image-capture processor 201 converts image data in the RGB data format to the JPEG data and then obtains the YUV data; however, the YUV data may be obtained without conversion to the JPEG data.

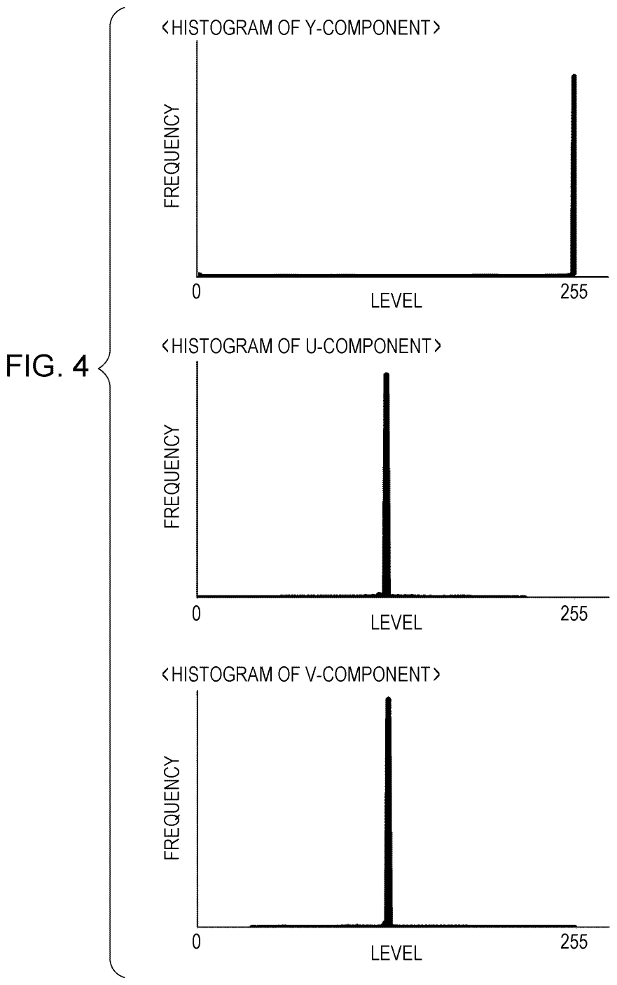

The background determiner 202 determines the range of a background color by analyzing image data. Herein, the background color refers to the color of a background of the original document 90. The range of the background color refers to the range of a color to be regarded as the background. The background determiner 202 creates histograms of pixel values of image data and determines the range of a background color based on the histograms. According to the present embodiment, the background determiner 202 creates histograms of pixel values of the YUV data. FIG. 4 is a graph illustrating an example of histograms when the original document 90 of white paper is scanned by the scanner 100. In this case, most of the pixels constituting an image are the pixels of white (Y=255, U=127, V=127), and therefore histograms as illustrated in FIG. 4 are obtained. Using, as a reference, the pixel value of a color corresponding to the vertex of a graph, that is, a color for which the frequency (that is, the number of pixels) reaches a peak, the background determiner 202 determines, as a range of the background color, colors included in a predetermined range from the reference.

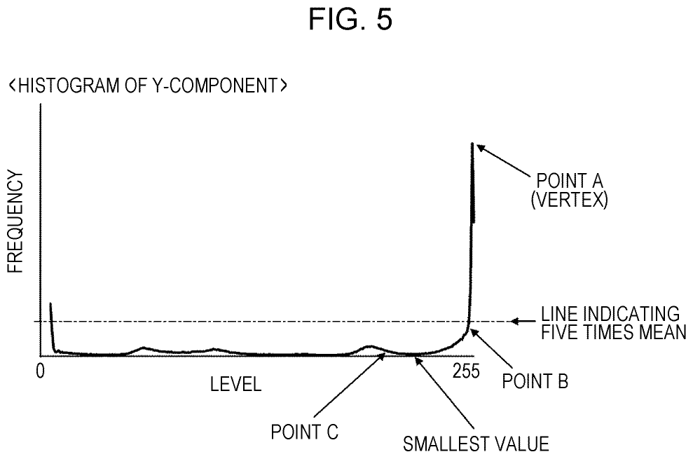

FIG. 5 is a schematic diagram of an example of a method of determining the range of a background color. Here is illustrated an example of a method of determining a background color when a white original document is assumed. First, the background determiner 202 detects the vertex (a point A) of a histogram. Then, starting from the point A, the background determiner 202 searches the graph in a direction of decreasing the pixel value, that is, a direction of increasing the darkness and ascertains the presence of a point B at which the frequency (the number of pixels) reaches a value less than or equal to a first predefined value. A non-limiting example of the first predefined value is five times the mean of frequencies of the histogram. Then, when the point B is found, starting from the point B, the background determiner 202 further searches the graph in the direction of decreasing the pixel value, that is, the direction of increasing the darkness and identifies a point C at which the frequency (the number of pixels) reaches a value greater than or equal to a second predefined value. A non-limiting example of the second predefined value is twice the smallest value of frequencies within the range that has been searched. Finally, the background determiner 202 determines the range from the level of a pixel value corresponding to the point C to a 255 level as the range of the background color. The method of determining the range of a background color may be any method of making a determination using the pixel value of a color for which the frequency reaches a peak, and is not limited to the method illustrated in FIG. 5.

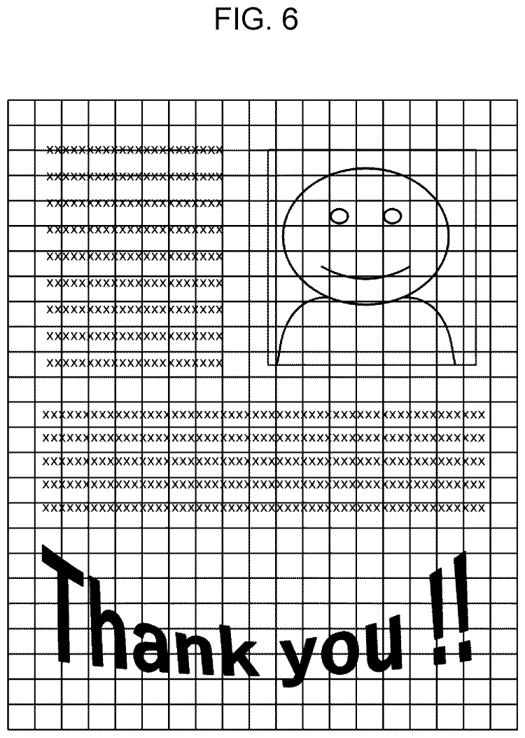

The pre-classifier 203 extracts a block including candidates for pixels constituting a character in an image represented by the image data. Herein, the block refers to a subarea obtained by dividing the entire area. Specifically, first, the pre-classifier 203 divides the entire area of an image represented by image data into a matrix of blocks with a predetermined size as illustrated in FIG. 6. According to the present embodiment, the pre-classifier 203 divides the image into blocks in 8 rows and 8 columns. Then, the pre-classifier 203 extracts blocks (subareas) including candidates for pixels constituting a character among all the blocks (all the subareas) obtained by dividing the image. Hereafter, the block including candidates for pixels constituting a character will be referred to as a character candidate block. The pre-classifier 203 extracts character candidate blocks based on the background color and on the distribution of colors of pixels included in each block.

According to the present embodiment, specifically, the pre-classifier 203 extracts character candidate blocks as follows. The pre-classifier 203 first identifies a background block, which is a block made only of the background, among all the generated blocks. Specifically, the pre-classifier 203 identifies, as the background block, a block composed only of pixels of pixel values included in the range of the background color determined by the background determiner 202. Hereafter, the pixels of pixel values included in the range of the background color will be referred to as a background pixel. The pre-classifier 203 also identifies a non-character block, which is a block that does not include a character, among all the generated blocks. Specifically, the pre-classifier 203 identifies, as a non-character block, a block in which the percentage of background pixels of the pixels included in the block is less than or equal to predetermined criteria and in which the distribution of colors of pixels other than the background pixels among the pixels included in the block meets predetermined conditions. The pixels other than the background pixels may be referred to as non-background pixels. According to the present embodiment, when the number of background pixels among 64 pixels included in a block is less than or equal to 10 and when a non-background pixel group included in the block includes pixels that differ from each other in luminance or color difference by 40 or more levels, the pre-classifier 203 identifies the block as a non-character block. Then, the pre-classifier 203 identifies, among all the generated blocks, all the remaining blocks, which are neither the background blocks nor the non-character blocks, as character candidate blocks.

The method of identifying character candidate blocks is not limited to the method described above. The character candidate block may be any block other than the blocks that have no possibility of including pixels constituting a character. Therefore, the pre-classifier 203 may extract, as character candidate blocks, all the blocks other than the background blocks. In addition, the pre-classifier 203 may extract, as non-character blocks, blocks in which the percentage of background pixels of the pixels included in the block is greater than or equal to the predetermined criteria. In addition, the pre-classifier 203 may extract, as non-character blocks, blocks in which the percentage of background pixels of the pixels included in the block is greater than or equal to the predetermined criteria and in which the variation in color of the non-background pixels included in the block is within a predetermined range.

The smoother 204 performs smoothing on the image data. According to the present embodiment, the smoother 204 performs smoothing for color difference data, that is, data on the U-component and V-component of the YUV data. In addition, according to the present embodiment, the smoother 204 performs smoothing on a character candidate block extracted by the pre-classifier 203. The smoother 204 corrects the color shifts of pixels constituting a character by performing the smoothing. In particular, the smoother 204 performs smoothing using the pixel values of pixels other than pixels of a background color among pixels included in an area to be processed. This will be specifically described. Specifically, the smoother 204 corrects the pixel value of a target pixel using a filter with a predetermined size. The smoother 204 uses, for example, a moving average filter and may use another known smoothing filter, such as a Gaussian filter. However, as described above, the smoother 204 does not correct the pixel value of a target pixel using the pixel values of all the pixels input to the smoothing filter but performs smoothing using only the pixel values of pixels other than background pixels among the pixels input to the smoothing filter. That is, the smoother 204 corrects the pixel value of the target pixel using only the pixel values of pixels other than background pixels among pixels input to the smoothing filter.

If the pixel value of the target pixel is corrected using the pixel values of all the pixels input to the smoothing filter, the pixel value of the target pixel is corrected such that the color of the target pixel is close to the color of a pixel that does not constitute a character, such as a background pixel. That is, such correction to delete the color features of a character pixel is performed. Therefore, when such correction is performed, it is difficult to appropriately correct the color shifts of pixels constituting a character. According to the present embodiment, as described above, the pixel value of the target pixel is corrected using only the pixel values of pixels other than the background pixels. Therefore, the pixel values of background pixels among pixels input to the smoothing filter do not affect the correction of the pixel value of the target pixel. Therefore, according to the present embodiment, it may be achieved to correct the color shifts of pixels constituting a character while excluding the effects of the pixel values of pixels that do not constitute the character. The smoother 204 may skip smoothing when the target pixel is a background pixel.

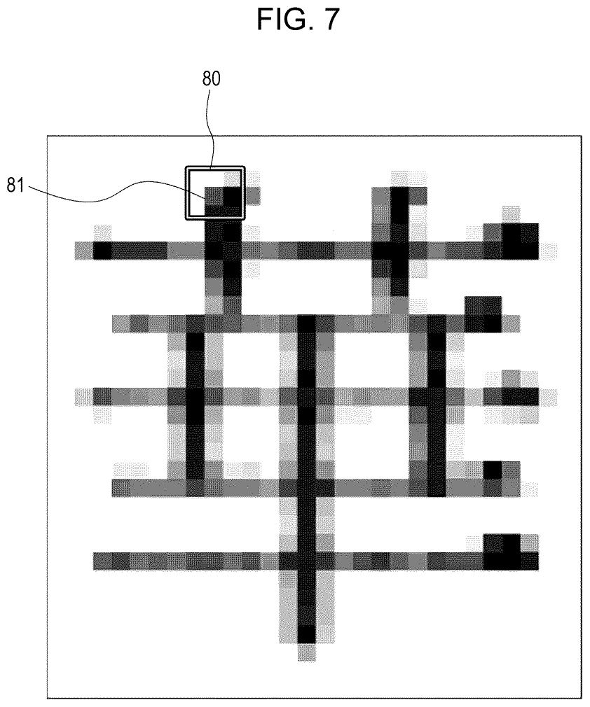

A specific example of the processing of the smoother 204 is described here with reference to figures. FIG. 7 is a schematic depiction of the range of pixels that are input to a smoothing filter for correction of some target pixel 81 in smoothing for an area including pixels constituting a character and background pixels. In FIG. 7, a target range 80 indicates the range of pixels that are input to the smoothing filter. In addition, the center pixel of the target range 80 is a target pixel 81 and is corrected by smoothing. Although the entirety of one character is depicted in the image in FIG. 7, FIG. 7 is a figure for ease of understanding and thus the entirety of one character is not necessarily included in one character candidate block.

Herein, the target range 80 is a range of 3 rows and 3 columns of pixels. Therefore, a filter with a size of 3 rows and 3 columns of pixels is used in the example depicted in FIG. 7. However, as described above, according to the present embodiment, all the pixels input to the filter are not necessarily used for smoothing.

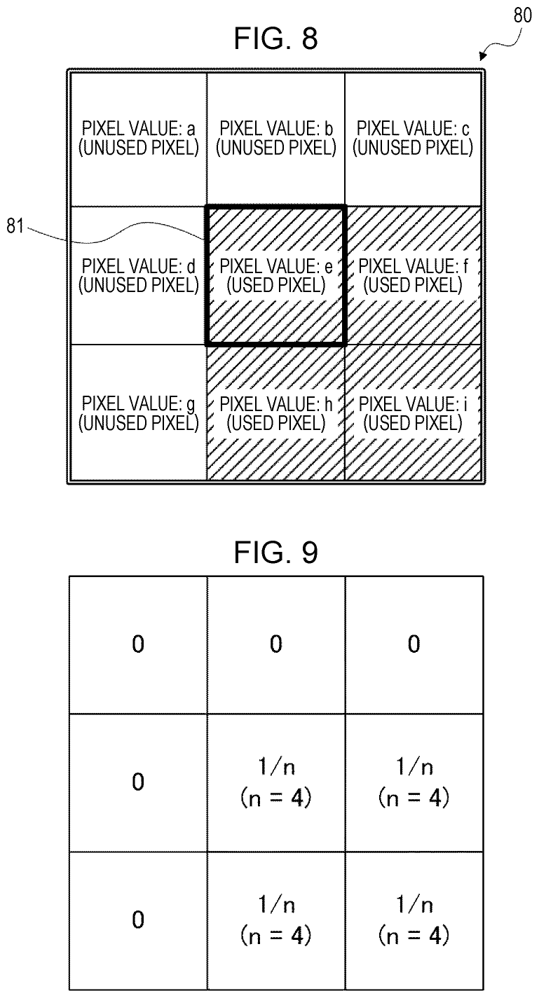

FIG. 8 is a schematic illustration illustrating whether each pixel included in the target range 80 depicted in FIG. 7 is used for smoothing. For the purpose of explanation, the pixel values of pixels are denoted by a, b, c, d, e, f, g, h, and i in order from the top left pixel as illustrated in FIG. 8. In the example in FIG. 7 and FIG. 8, the pixel values (a, b, and c) of three pixels in the first row from the top in the target range 80 are all included in the range of the background color determined by the background determiner 202. In addition, the pixel value (d) of the leftmost pixel in the second row from the top and the pixel value (g) of the leftmost pixel in the third row from the top in the target range 80 are also included in the range of the background color determined by the background determiner 202. Therefore, these five pixels are determined as background pixels and thus are not used for smoothing. The remaining four pixels in the target range 80, that is, four pixels with pixel values out of the range of the background color are determined as pixels other than the background pixels and thus are used for smoothing.

That is, the smoother 204 excludes the pixels with pixel values included in the range of the background color, as background pixels, from the pixel group input to the filter. Then, the smoother 204 calculates a weighted average for the pixel values of the remaining pixels. In the case of a moving average filter, a weighted average will be calculated such that all the weights assigned to the pixel values of pixels to be used are the same. For example, in the example illustrated in FIG. 8, the smoother 204 performs smoothing using a moving average filter with a filter coefficient as illustrated in FIG. 9. In such a manner, an example of the filter coefficient for pixel values used for smoothing is defined using the number n of pixels other than the background pixels in the target range 80 and a predetermined weight. In the example in FIG. 8, n=4. Then, the smoother 204 performs a multiply-accumulate operation using such a filter coefficient and the pixel values. The smoother 204 may perform a multiply-accumulate operation targeting for only pixels other than the background pixels; however, as illustrated in FIG. 9, the smoother 204 may also perform a multiply-accumulate operation for all the pixels in the target range 80 such that 0 is used as a filter coefficient for the background pixels in the target range 80. In the example illustrated in FIG. 8 and FIG. 9, as a result of the smoothing, the corrected pixel values of the target pixels 81 are specifically e/4+f/4+h/4+i/4.

According to the present embodiment, as described above, the smoother 204 causes, in the area of the image represented by image data, only blocks (subareas) each including candidates for pixels constituting a character to be subjected to smoothing. That is, according to the present embodiment, smoothing is performed only on character candidate blocks. Therefore, the volume of smoothing may be reduced. The object subjected to smoothing performed by the smoother 204 may not be limited only to the character candidate blocks. In this case, the image processing device 200 may not include the pre-classifier 203.

The classifier 205 analyzes image data on which smoothing has been performed by the smoother 204 to differentiate between a pixel constituting a character and a pixel constituting a non-character in an image represented by the image data. According to the present embodiment, specifically, the classifier 205 differentiates between a pixel constituting a character and a pixel constituting a non-character as follows.

First, for each character candidate block after the smoothing, the classifier 205 determines again the block type. Specifically, for each character candidate block after the smoothing, the classifier 205 creates histograms of pixel values and determines again whether the character candidate block includes a pixel constituting a character. When the percentage of background pixels of the pixels included in the block is greater than or equal to the predetermined criteria and the non-background pixels after smoothing are a single color, the classifier 205 determines that the character candidate block to be determined is a block including pixels constituting a character, that is, a character block. The single color as used here is not limited to a single color represented by a specific pixel value and may include colors close thereto. The colors close to the single color represented by a specific pixel value refer to colors represented by pixel values that differ from the pixel value of the single color within a predetermined range. That is, for example, the colors close to red refer to colors that may be regarded as red. When the color of a non-background pixel of a block determined as a character block is an achromatic color, the classifier 205 determines that the character block is a block (black character block) including a pixel constituting a black character. In contrast, when the color of a non-background pixel of a block determined as a character block is a chromatic color, the classifier 205 determines that the character block is a block (color character block) including a pixel constituting a color character. Then, the classifier 205 determines that the character candidate block that has not been determined as a character block is a block (non-character block) including pixels constituting a non-character. By executing the above process, a block including pixels constituting a character, that is, a subarea is identified.

Then, the classifier 205 creates histograms of pixel values of all the black character blocks and determines the range of colors of the black character based on the histograms. That is, the classifier 205 determines the range of colors to be regarded as a black character. For example, using, as a reference, the pixel value at which the frequency, that is, the number of pixels reaches a peak, the classifier 205 determines, as the range of colors of a black character, colors included in a predetermined range from the reference. Likewise, the classifier 205 creates histograms of pixel values of all the color character blocks and determines the range of colors of the color character based on the histograms. That is, the classifier 205 determines the range of colors to be regarded as a color character. For example, using, as a reference, the pixel value at which the frequency, that is, the number of pixels reaches a peak, the classifier 205 determines, as a range of colors of a color character, colors included in a predetermined range from the reference. When there are N (where N is an integer greater than or equal to two) types of color characters that differ in color from each other, the classifier 205 determines the range of colors of each of the N types of color characters. For example, when a plurality of peaks are present in a histogram, from each of the peaks, the classifier 205 determines the range of colors of each of the plurality of types of color characters. Thereby, the range of colors is determined for each color of a character, for example, such as the range of colors of a red character and the range of colors of a blue character. The method of determining the range of colors of a character may be any method of making a determination using a histogram of the pixel values of pixels after smoothing, and is not limited to the method described above.

Then, using the range of colors of a character, the classifier 205 classifies each pixel included in the entire image represented by image data, as a pixel constituting a character or a pixel constituting a non-character. That is, the classifier 205 classifies pixels having pixel values included in the range of colors of a character into pixels constituting a character and classifies pixels having pixel values that are not included in the range of colors of the character into pixels that do not constitute the character. In particular, the classifier 205 classifies pixels having pixel values included in the range of colors of a black character into pixels constituting the black character. Likewise, the classifier 205 classifies pixels having pixel values included in the range of colors of a color character into pixels constituting the color character. From the above, the classifier 205 differentiate between a pixel constituting a character and a pixel constituting a non-character in an image represented by the image data. In particular, the classifier 205 differentiates pixels constituting a character for each color of the character. For pixels constituting a non-character, the classifier 205 may further differentiate between a pixel constituting a background and a pixel constituting an illustration such as a photograph. In this case, for example, the classifier 205 classifies, among pixels determined to constitute a non-character, a pixel having a pixel value included in the range of a background color determined by the background determiner 202 as a pixel constituting a background. In addition, the classifier 205 classifies, among pixels determined to constitute a non-character, a pixel that is classified neither as a pixel constituting a character nor as a pixel constituting a background, as a pixel constituting an illustration.

In addition, the classifier 205 determines a display color for each of a black character and a color character. The display color is a color that is associated with a character layer during compression processing and is a color that is used when the compressed data is decoded and the decoded data is displayed. That is, when the compressed data is decoded and the decoded data is displayed, the character will be displayed in the display color determined here. Using histograms generated in determining the range of colors of a character, the classifier 205 determines the display colors of a black character and a color character. When there are N (where N is an integer greater than or equal to two) types of color characters that differ in color from each other, the classifier 205 determines the display color of each of the N types of color characters. The classifier 205 determines a display color based on the pixel value at which the frequency, that is, the number of pixels reaches a peak. For example, the classifier 205 determines, as a display color, a color identified by the pixel value at which the frequency reaches a peak. The method of determining a display color may be any method of making a determination using histograms of the pixel values of pixels after smoothing, and is not limited to the method described above.

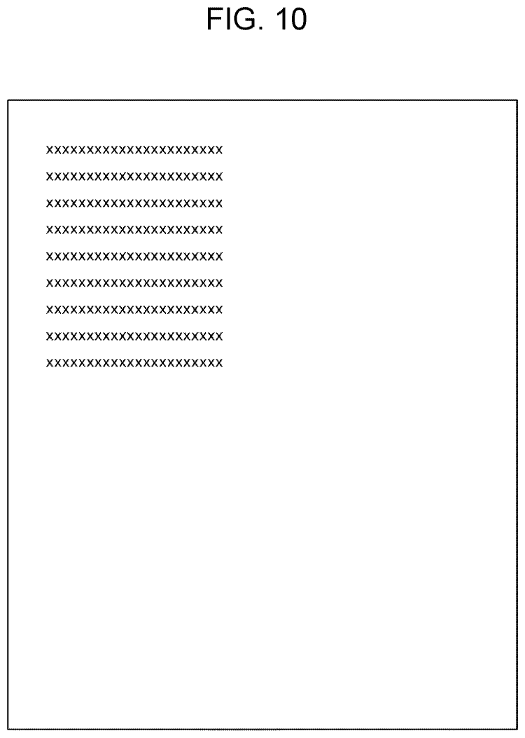

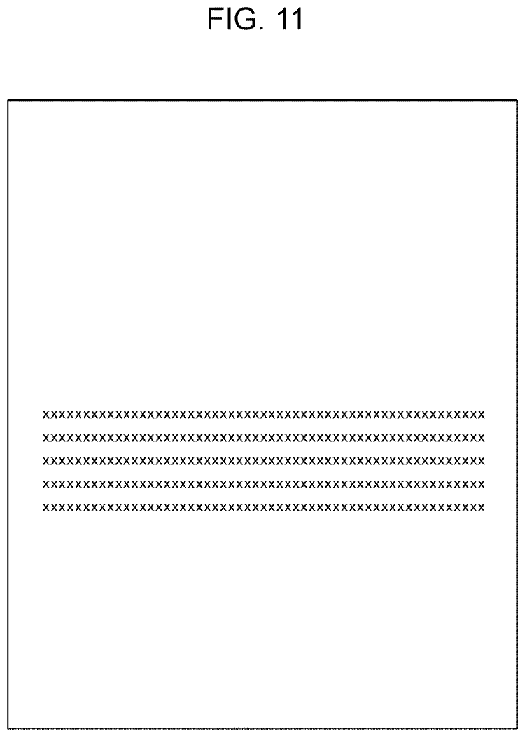

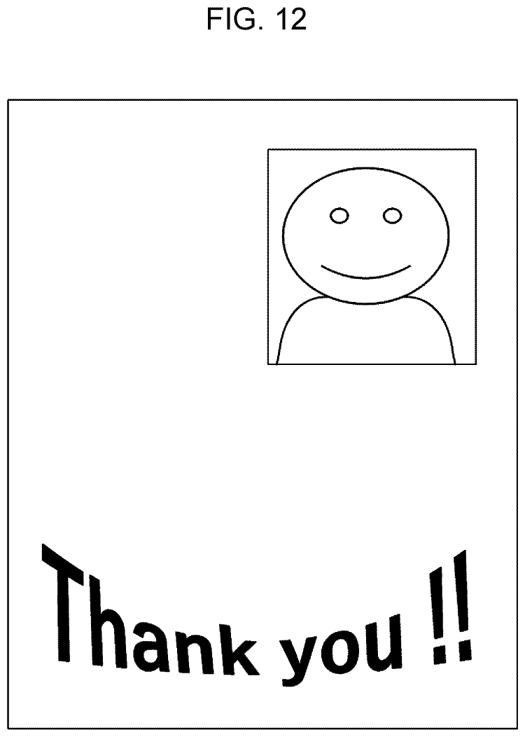

According to the differentiation between pixels performed by the classifier 205, the layer generator 206 generates, from image data, a character layer, which is a layer including pixels constituting a character, and a non-character layer, which is a layer including pixels constituting a non-character. Specifically, the layer generator 206 extracts only pixels constituting a character from image data and generates, as a character layer, an image composed only of the extracted pixels. According to the differentiation of pixels, the layer generator 206 generates a character layer for each color of the character. In addition, the layer generator 206 extracts only pixels constituting a non-character from image data and generates, as a non-character layer, an image composed only of the extracted pixels. FIG. 10 to FIG. 12 are schematic depictions representing examples of non-character layers generated for the original document 90 illustrated in FIG. 3 by the layer generator 206. FIG. 10 depicts a character layer composed of pixels constituting the character string 92a, which is the black character string in the original document 90 in FIG. 3. In addition, FIG. 11 depicts a character layer composed of pixels constituting the character string 92b, which is the red character string in the original document 90 in FIG. 3. In addition, FIG. 12 depicts a non-character layer composed of pixels constituting the background 91 and the illustrations 93a and 93b in the original document 90 in FIG. 3.

According to differentiation between the pixels performed by the classifier 205, the layer generator 206 may further generate, as non-character layers, a background layer, which is a layer including pixels constituting a background, and an illustration layer, which is a layer including pixels constituting an illustration, from image data. In this case, the layer generator 206 extracts only pixels constituting a background from the image data and generates, as a background layer, an image composed only of the extracted pixels. The layer generator 206 then extracts only pixels constituting an illustration from the image data and generates, as an illustration layer, an image composed only of the extracted pixels. In such a manner, a plurality of types of layers are generated as non-character layers. This enables more flexible compression in accordance with the types of layers.

The compression section 207 compresses a character layer and a non-character layer generated by the layer generator 206 by respectively different compression methods. The compression section 207 reversibly compresses the character layer and irreversibly compresses the non-character layer. In particular, the compression section 207 compresses a character layer by binarizing the character layer. That is, the compression section 207 generates binary data representing a character layer and then performs compression processing. The binary data is data in which a first value (for example, 1) is disposed at the locations of pixels constituting a character and a second value (for example, 0) is disposed at the other locations. According to the present embodiment, Modified Modified READ (MMR) compression is used as a compression method for a character layer; however, another known compression method that compresses binary data may be used. The compression section 207 performs compression processing for each character layer and further associates each piece of the compressed data with a display color corresponding to the character layer. The size of data generated by compressing binary data is generally smaller than, for example, JPEG data. According to the present embodiment, regarding a character layer, compression of binary data is performed, thereby enabling reduction in data size while suppressing degradation in the image quality of a character. In addition, particularly, according to the present embodiment, since a character layer is generated for each color of a character, compressed data may be appropriately generated for each color of a character even when a plurality of types of colors of characters are in the original document 90.

Regarding a non-character layer, the compression section 207 may thin pixels and then perform compression processing. For example, the compression section 207 may reduce the non-character layer to one quarter of the original size by reducing by half the pixels in the row direction of an image represented by a non-character layer and also reducing by half the pixels in the column direction, and then may perform compression processing. According to the present embodiment, the compression section 207 compresses a non-character layer by the JPEG method. When a background layer and an illustration layer are generated as non-character layers, the compression section 207 may compress the background layer and the illustration layer at different compression ratios. For example, the compression section 207 may reduce the background layer to the one-eighth of the original size by thinning pixels and then compress the background layer by the JPEG method, and may reduce the illustration layer to one quarter of the original size by thinning pixels and then compress the illustration layer by the JPEG method. In such a manner, the compression section 207 may reduce the background layer at a higher compression ratio than the illustration layer. This enables the data size after compression to be small while suppressing degradation in an illustration.

The merger 208 generates a file into which data on the compressed character layer data and data on the compressed non-character layer are merged. As described above, in this file, the character layer data is associated with a display color corresponding to the character layer. In such a manner, the merger 208 merges data output from the compression section 207 into a single image data file. According to the present embodiment, specifically, the merger 208 merges these pieces of data as a PDF file. That is, the merger 208 uses the compressed data to generate a file according to the PDF format.

The outputter 209 outputs the file generated by the merger 208 to a specified output destination. The outputter 209 may, for example, output the file to a storage device or a memory included in the scanning system 10 or a portable memory coupled to the scanning system 10 and transmit the file to another device communicatively coupled to the scanning system 10.

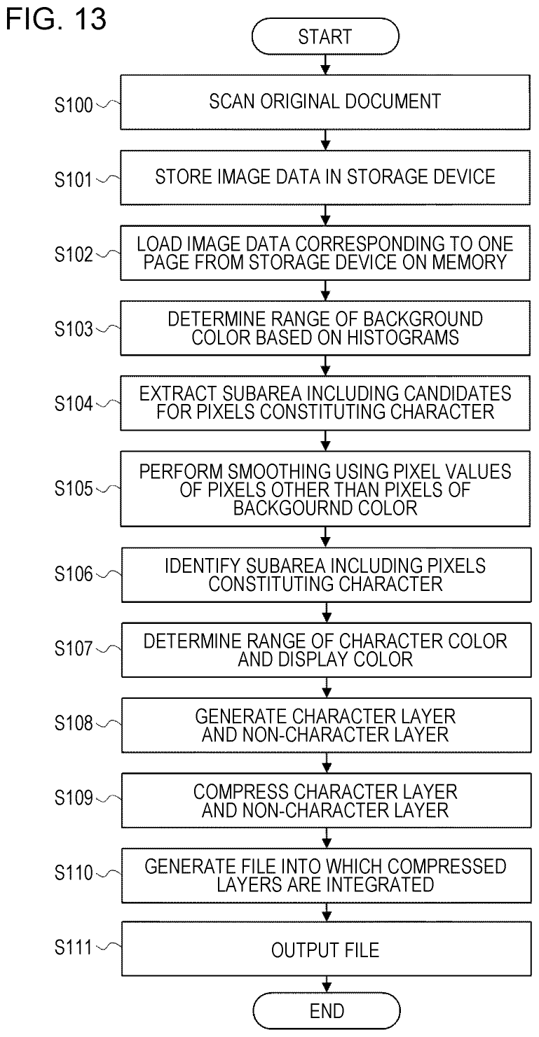

The flow of operations of the scanning system 10 will now be described. FIG. 13 is a flowchart illustrating an example of the flow of operations of the scanning system 10. With reference to FIG. 13, the flow of operations of the scanning system 10 is described below.

At step S100, the scanner 100 scans an original document to generate image data.

Then, at step S101, the image-capture processor 201 temporarily stores the image data output from the scanner 100 in a storage device. As described above, according to the present embodiment, the image-capture processor 201 converts image data to JPEG data and then stores the JPEG data in the storage device.

Then, at step S102, the image-capture processor 201 loads image data corresponding to one page from the storage device onto a memory. As described above, according to the present embodiment, the image-capture processor 201 decodes the JPEG data read out from the storage device into RGB data and further converts the RGB data to YUV data, and stores the YUV data in a memory.

Then, at step S103, the background determiner 202 creates histograms of image data (YUV data) stored in the memory and determines the range of a background color based on the histograms.

Then, at step S104, the pre-classifier 203 extracts character candidate blocks, each of which is a block (subarea) including candidates for pixels constituting a character, based on the determined range of the background color.

Then, at step S105, the smoother 204 performs smoothing using the pixel values of pixels other than pixels of the background color. According to the present embodiment, the smoother 204 performs smoothing on the character candidate blocks.

Then, at step S106, for each character candidate block after the smoothing, the classifier 205 determines again the block type. In particular, at this step, for character candidate blocks after the smoothing, histograms of pixel values are created, and at least a block (subarea) including pixels constituting a character is identified based on the histograms.

Then, at step S107, the classifier 205 determines the range of colors of the character and the display color based on the histograms of the block identified as a block including a pixel constituting the character. By determining the range of colors of a character, the classifier 205 identifies whether each pixel composing the image is a pixel constituting a character.

Then, at step S108, the layer generator 206 generates a character layer including pixels constituting a character and a non-character layer including pixels constituting a non-character.

Then, at step S109, the compression section 207 compresses the generated character layer and the generated non-character layer by respectively different compression methods.

Then, at step S110, the merger 208 generates a PDF file into which the compressed layers are merged.

Finally, at step S111, the outputter 209 outputs the PDF file to a specified output destination.

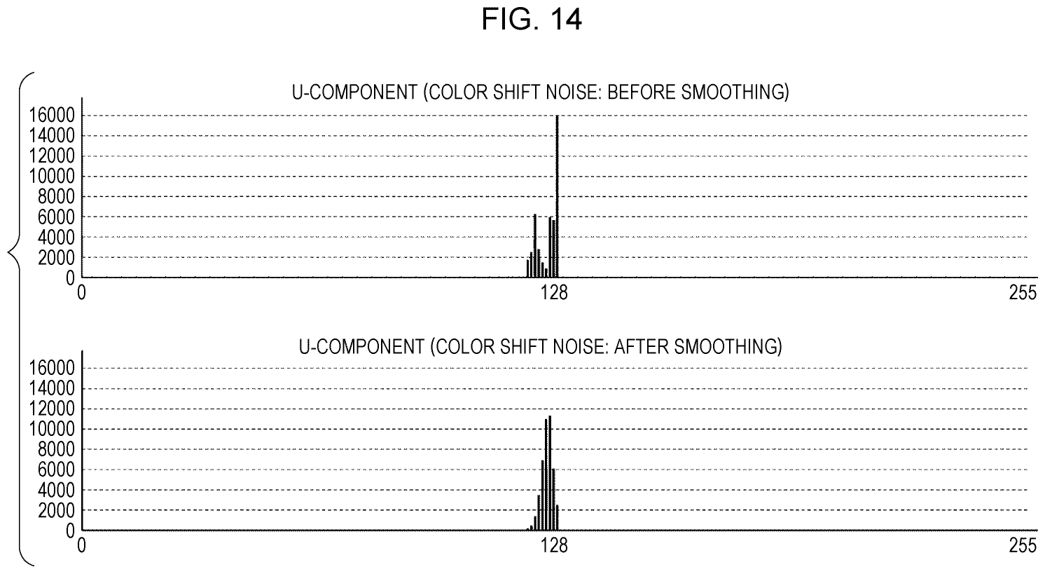

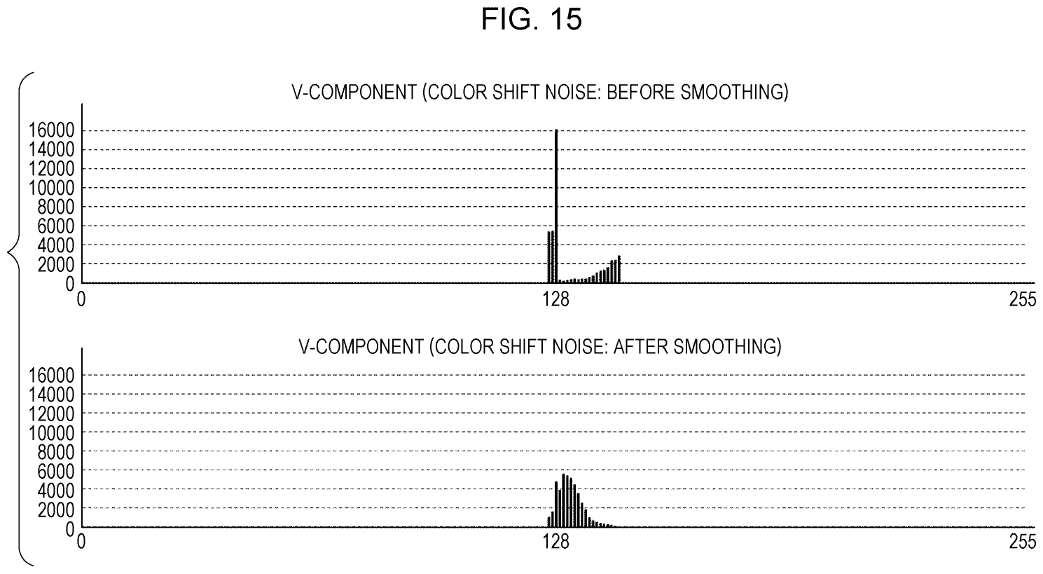

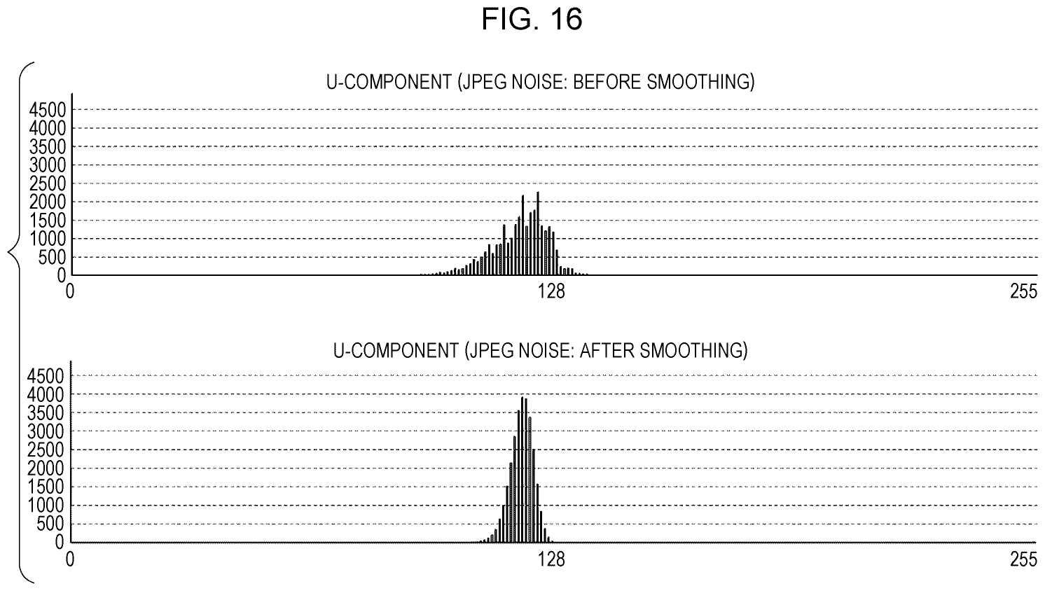

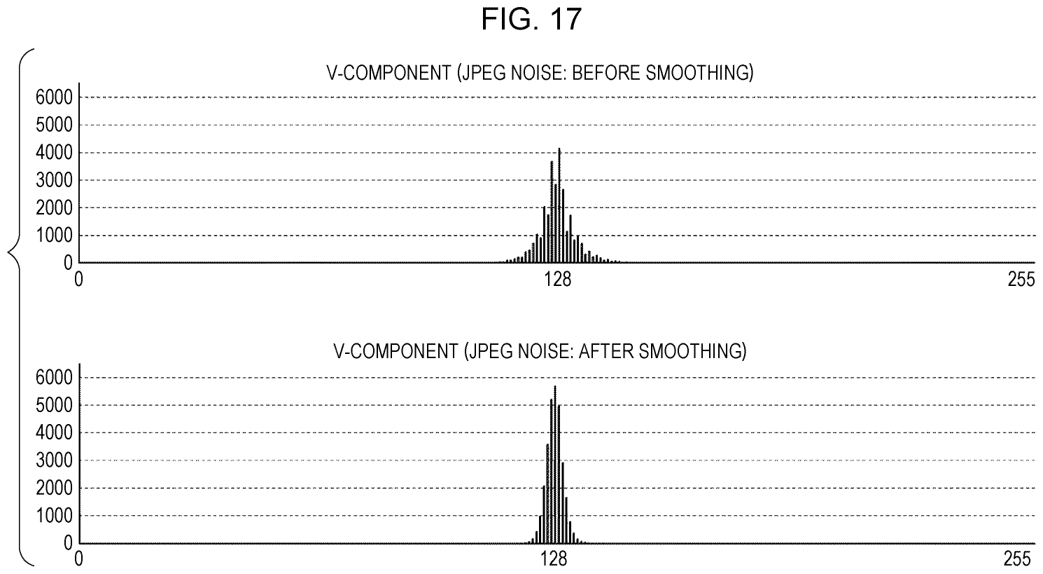

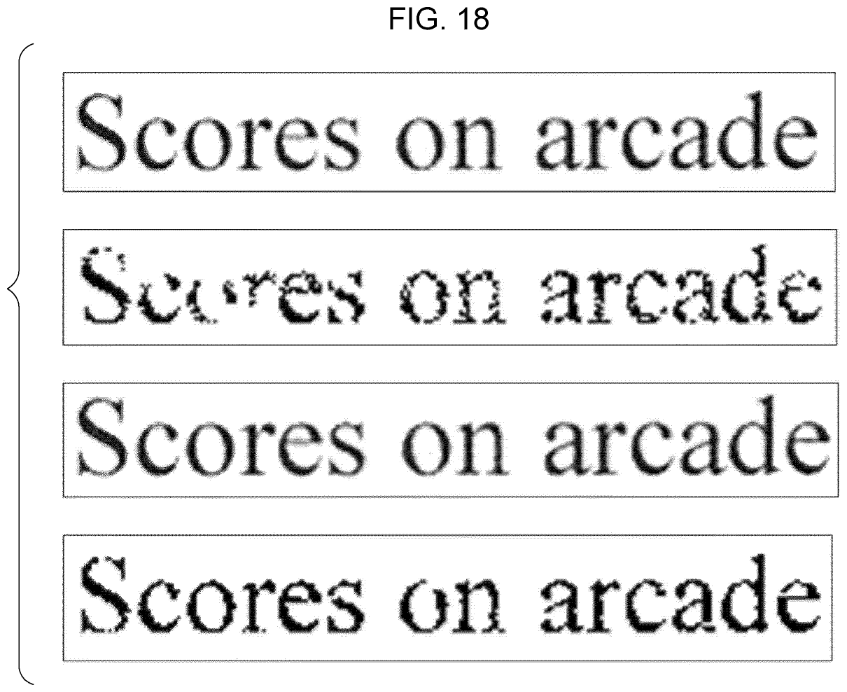

An experimental result of the processing described above of the scanning system 10 is now presented. FIG. 14 and FIG. 15 include diagrams illustrating effects of correction of color shifts caused by scanning. In FIG. 14 and FIG. 15, the graph at the top is a histogram of pixel values of a black character before smoothing performed by the smoother 204, and the graph at the bottom is a histogram after the smoothing performed by the smoother 204. FIG. 14 illustrates histograms of the U-component, and FIG. 15 illustrates histograms of the V-component. FIG. 16 and FIG. 17 include diagrams illustrating effects of correction of noise caused by conversion to JPEG data. In FIG. 16 and FIG. 17, the graph at the top is a histogram of pixel values of a black character before smoothing performed by the smoother 204, and the graph at the bottom is a histogram after the smoothing performed by the smoother 204. FIG. 16 illustrates histograms of the U-component, and FIG. 17 illustrates histograms of the V-component. As understood from FIGS. 14 to 17, the color shifts (noise) are appropriately corrected by smoothing performed with exclusion of pixel values of background colors, which is performed by the smoother 204.

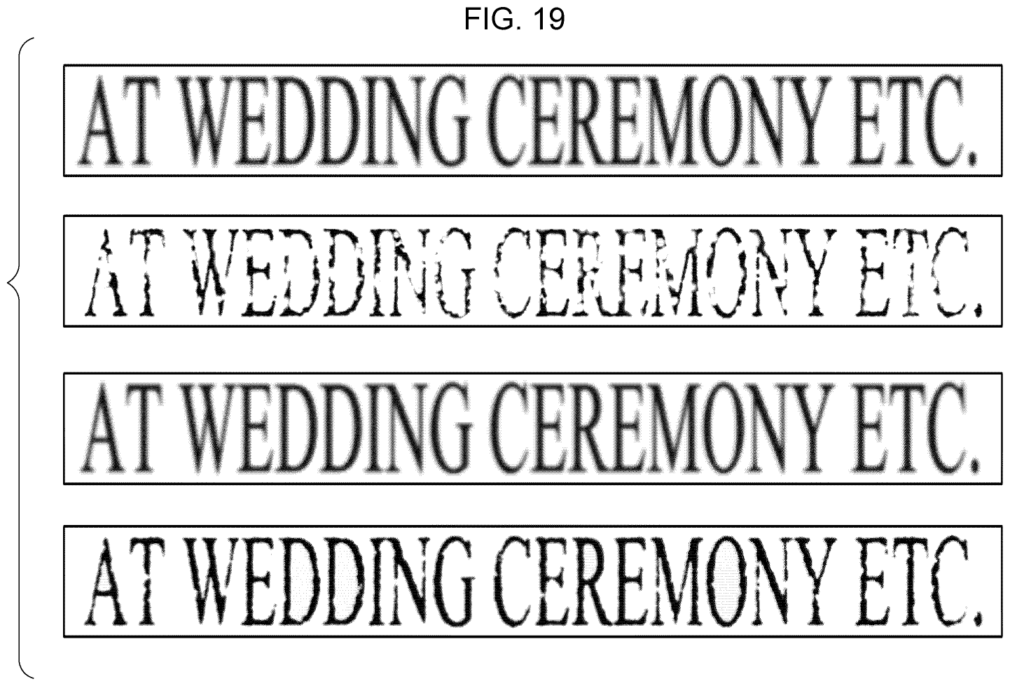

In addition, FIG. 18 and FIG. 19 each illustrate a comparison of processing results obtained when smoothing is performed without exclusion of pixel values of a background color and when smoothing is performed with exclusion of pixel values of the background color. In FIG. 18 and FIG. 19, the top image represents an original image. In addition, in FIG. 18 and FIG. 19, the image at the second from the top represents a character layer generated when smoothing is performed on the original image without excluding the pixel values of a background color. That is, the image at the second from the top represents a comparison example. In addition, in FIG. 18 and FIG. 19, the image at the third from the top represents an image after smoothing according to the present embodiment and the image at the fourth from the top represents a character layer generated according to the present embodiment. As illustrated in FIG. 18 and FIG. 19, according to the present embodiment, character layers are generated more accurately than in the comparison examples.

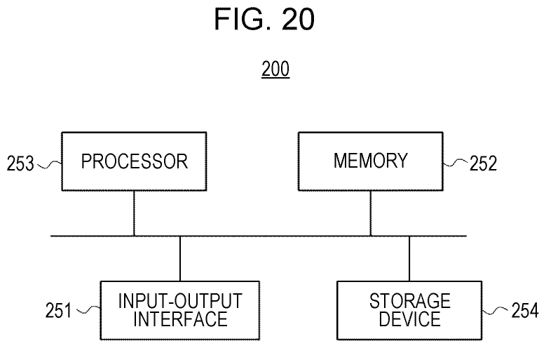

Finally, an exemplary hardware configuration of the image processing device 200 is described. FIG. 20 is a block diagram illustrating an exemplary hardware configuration of the image processing device 200. The image processing device 200 is a device having a function of a computer. As illustrated in FIG. 20, the image processing device 200 includes, for example, an input-output interface 251, a memory 252, a processor 253, and a storage device 254.

The input-output interface 251 is used for communication with another device such as the scanner 100.

The memory 252 includes a RAM. According to the present embodiment, YUV data is stored in the memory 252 as mentioned above. The memory 252 may be used for storing software (computer programs) including one or more instructions to be executed by the processor 253.

As used herein, software (computer programs) includes an instruction set (or software code) that, when read by a computer, causing the computer to execute one or more functions described in the embodiment. The programs may be stored in a non-transitory computer-readable medium or a solid storage medium. Non-limiting examples of the computer-readable medium or the solid storage medium include RAM, read-only memory (ROM), flash memory, solid-state drive (SSD) or other memory techniques, a compact disk read-only memory (CD-ROM), a digital versatile disk (DVD), a Blue-ray (registered trademark) disk or other optical disk storages, magnetic cassettes, magnetic tape, magnetic disk storage or other magnetic storage devices. The programs may be transmitted in a transitory computer-readable medium or a communication medium. Non-limiting examples of the transitory computer-readable medium or communication medium include electrical, optical, acoustical or other forms of propagated signals.

The processor 253 may be, for example, a microprocessor, a micro processor unit (MPU), or a central processing unit (CPU). The processor 253 may include a plurality of processors. Processing of the components of the image processing device 200 illustrated in FIG. 2 is performed by the processor 253 reading out a computer program from the memory 252 and executing the program.

The storage device 254 is a device that stores data for use for processing, and is constituted by, for example, a hard disk drive (HDD), a magnetic tape, an optical disk, a SSD, or the like. According to the present embodiment, JPEG data is stored in the storage device 254 as mentioned above.

The embodiments have been described above. According to the present embodiment, color shifts are corrected by smoothing. This enables pixels constituting a character to be identified more appropriately than the case where correction is not performed. In addition, processing performed to address a disadvantage of color shifts according to the present embodiment is smoothing, and thinning processing and processing of removing edge pixels are not performed. Therefore, processing is appropriately implemented regardless of whether an image to be processed is an image of a character drawn with a fine line. In addition, particularly, smoothing according to the present embodiment is performed using the pixel values of pixels other than pixels of the background color. Therefore, undesirable correction, in which, for example, the color of a pixel constituting a character is close to the background color, may be reduced. That is, by smoothing according to the present embodiment, correction for the colors of pixels constituting a character may be made more appropriately.

The present disclosure is not limited to the embodiments described above and may be changed as appropriate without departing from the spirit and scope of the disclosure. For example, although, in the embodiments described above, the filter used for smoothing has a size of three rows and three columns, the size of the filter is not limited to this. In addition, the shape of the filter is not necessarily a square. For example, the shape of the filter is not necessarily an oblong. In this case, the size of a filter in the direction of scanning of the scanner 100, that is, the size of a filter in the sub scanning direction may be longer than the size of the direction perpendicular to this direction, that is, the size of the main scanning direction. For example, when an original document is scanned by the scanner 100, color shifts might occur in the sub scanning direction, that is, the color components of some pixel might be distributed in the adjacent pixel in the sub scanning direction. In such cases, a filter that is long in the sub scanning direction may be used.

Some or all of the embodiments described above may be described as, but not limited to, the following appendices.

Appendix 1: A scanning system comprising:
a scanner configured to scan an original document to generate image data;
a smoother configured to perform smoothing on the image data;
a classifier configured to analyze the image data on which the smoothing is performed, to differentiate between a pixel constituting a character and a pixel constituting a non-character in an image represented by the image data;
a layer generator configured to, according to the differentiation between the pixels, generate, from the image data, a character layer including the pixel constituting a character and a non-character layer including the pixel constituting a non-character;
a compression section configured to compress the character layer and the non-character layer by respectively different compression methods; and
a merger configured to generate a file into which data on the compressed character layer and data on the compressed non-character layer are merged,
wherein the smoother performs the smoothing using a pixel value of a pixel other than a pixel of a background color among pixels included in an area to be processed.

Appendix 2: The scanning system according to appendix 1, wherein
the smoother is configured to cause, in an area of the image represented by the image data, only a subarea including a candidate for the pixel constituting a character to be subjected to the smoothing.

Appendix 3: The scanning system according to appendix 1 or 2, wherein
the classifier is configured to, for the pixel constituting a non-character, further differentiate between a pixel constituting a background and a pixel constituting an illustration, and
the layer generator is configured to, according to the differentiation between the pixels, further generate, as the non-character layer, a background layer, the background layer being a layer including the pixel constituting a background, and an illustration layer, the illustration layer being a layer including the pixel constituting an illustration, from the image data.

Appendix 4: The scanning system according to any one of appendices 1 to 3, wherein
the compression section is configured to compress the character layer by binarizing the character layer.

Appendix 5: The scanning system according to any one of appendices 1 to 4, wherein
the classifier is configured to analyze the image data on which the smoothing is performed, to differentiate a pixel constituting a character for each color of the character, and
the layer generator is configured to, according to the differentiation of the pixel, generate the character layer for each color of the character.

Appendix 6: A file generating method comprising:
performing smoothing on image data;
analyzing the image data on which the smoothing is performed, to differentiate between a pixel constituting a character and a pixel constituting a non-character in an image represented by the image data;
according to the differentiation between the pixels, generating a character layer, the character layer being a layer including the pixel constituting a character, and a non-character layer, the non-character layer being a layer including the pixel constituting a non-character, from the image data;
compressing the character layer and the non-character layer by respectively different compression methods; and
generating a file into which data on the compressed character layer and data on the compressed non-character layer are merged,
wherein, in the smoothing, processing is performed using a pixel value of a pixel other than a pixel of a background color among pixels included in an area to be processed.

Appendix 7: A non-transitory computer-readable storage medium storing a program that causes a computer to execute:
a smoothing step of performing smoothing on image data;
a classifying step of analyzing the image data on which the smoothing is performed, to differentiate between a pixel constituting a character and a pixel constituting a non-character in an image represented by the image data;
a layer generating step of, according to the differentiation between the pixels, generating a character layer, the character layer being a layer including the pixel constituting a character, and a non-character layer, the non-character layer being a layer including the pixel constituting a non-character, from the image data;
a compressing step of compressing the character layer and the non-character layer by respectively different compression methods; and
a merging step of generating a file into which data on the compressed character layer and data on the compressed non-character layer are merged,
wherein, in the smoothing step, the smoothing is performed using a pixel value of a pixel other than a pixel of a background color among pixels included in an area to be processed.

What is claimed is:

1. A scanning system comprising:
a scanner configured to scan an original document to generate image data;
a smoother configured to perform smoothing on the image data;
a classifier configured to analyze the image data on which the smoothing is performed, to differentiate between a pixel constituting a character and a pixel constituting a non-character in an image represented by the image data;
a layer generator configured to, according to the differentiation between the pixels, generate, from the image data, a character layer including the pixel constituting a character and a non-character layer including the pixel constituting a non-character;
a compression section configured to compress the character layer and the non-character layer by respectively different compression methods; and
a merger configured to generate a file into which data on the compressed character layer and data on the compressed non-character layer are merged,
wherein the smoother performs the smoothing using a pixel value of a pixel other than a pixel of a background color among pixels included in an area to be processed.

2. The scanning system according to claim 1, wherein
the smoother is configured to cause, in an area of the image represented by the image data, only a subarea including a candidate for the pixel constituting a character to be subjected to the smoothing.

3. The scanning system according to claim 1, wherein
the classifier is configured to, for the pixel constituting a non-character, further differentiate between a pixel constituting a background and a pixel constituting an illustration, and
the layer generator is configured to, according to the differentiation between the pixels, further generate, as the non-character layer, a background layer, the background layer being a layer including the pixel constituting a background, and an illustration layer, the illustration layer being a layer including the pixel constituting an illustration, from the image data.

4. The scanning system according to claim 1, wherein the compression section is configured to compress the character layer by binarizing the character layer.

5. The scanning system according to claim 1, wherein
the classifier is configured to analyze the image data on which the smoothing is performed, to differentiate a pixel constituting a character for each color of the character, and the layer generator is configured to, according to the differentiation of the pixel, generate the character layer for each color of the character.

6. The scanning system according to claim 1, wherein the merger is configured to generate a portable document format (PDF) file including the character layer and the non-character layer.

7. A file generating method comprising:
performing smoothing on image data;
analyzing the image data on which the smoothing is performed, to differentiate between a pixel constituting a character and a pixel constituting a non-character in an image represented by the image data;
according to the differentiation between the pixels, generating a character layer, the character layer being a layer including the pixel constituting a character, and a non-character layer, the non-character layer being a layer including the pixel constituting a non-character, from the image data;
compressing the character layer and the non-character layer by respectively different compression methods; and
generating a file into which data on the compressed character layer and data on the compressed non-character layer are merged,
wherein, in the smoothing, processing is performed using a pixel value of a pixel other than a pixel of a background color among pixels included in an area to be processed.

8. A non-transitory computer-readable storage medium storing a program that causes a computer to execute:
a smoothing step of performing smoothing on image data;
a classifying step of analyzing the image data on which the smoothing is performed, to differentiate between a pixel constituting a character and a pixel constituting a non-character in an image represented by the image data;
a layer generating step of, according to the differentiation between the pixels, generating a character layer, the character layer being a layer including the pixel constituting a character, and a non-character layer, the non-character layer being a layer including the pixel constituting a non-character, from the image data;
a compressing step of compressing the character layer and the non-character layer by respectively different compression methods; and
a merging step of generating a file into which data on the compressed character layer and data on the compressed non-character layer are merged,
wherein, in the smoothing step, the smoothing is performed using a pixel value of a pixel other than a pixel of a background color among pixels included in an area to be processed.
